(19) United States
(12) Patent Application Publication
(10) Pub. No.: US 2022/0015285 A1
(43) Pub. Date: Jan. 20, 2022

(54) Resweep Attachment for Replanting with Planter Row Unit

(71) Applicant: Nelson Zehr, Fairbury, IL (US)

(72) Inventor: Nelson Zehr, Fairbury, IL (US)

(21) Appl. No.: 17/305,402

(22) Filed: Jul. 7, 2021

Related U.S. Application Data
(60) Provisional application No. 62/705,785, filed on Jul. 15, 2020.

(51) Int. Cl. A01C 7/20; A01C 5/06

(52) U.S. Cl. CPC A01C 7/203; A01C 5/064

(57) ABSTRACT

A planter assembly for removing an existing stand with a resweep attachment and planting new seed with a planter row unit. A cultivator sweep is mounted to a planter assembly upheld of a planter row unit via an attachment stem. The attachment stem may laterally position the sweep to destroy the previous crop and may position the sweep to align with the seed tube. Prescriptive downforce/upforce control over individual planter row units allows an operator to selectively manage individual rows for replanting to optimize operational efficiency and maximize crop production yield potential.

### CROSS REFERENCES

This application is a non-provisional application claiming priority of U.S. Provisional Application No. 62/705,785 filed 15 Jul. 2020.

### REFERENCE TO RESEARCH

Not Applicable.

### REFERENCE TO CDS

Not Applicable.

### FIELD OF THE INVENTION

The present disclosure relates to machines for both removing an existing crop row stand and replanting the row.

### BACKGROUND

Obtaining an acceptable crop stand requires numerous factors, including: soil preparation, weather, mechanical issues, treatments, and nutrition. For some crops and in some locations, there is a very short window of time to establish an acceptable crop in order to obtain an expected harvest.

### SUMMARY

A planter assembly having a planter row unit and a planter attachment mounted to the planter row unit. The planter attachment is made up of an attachment stem and a cultivator sweep. The cultivator sweep is mounted to the attachment stem. The cultivator sweep planter attachment may be operable to engage the ground at a cultivator depth that is between 1″ and 2.75″ less than a planting depth of the row planting unit.

The planter row unit may have a gauge wheel that determines the planting depth of the planter row unit. The planter attachment may be mounted to the planter assembly such that the cultivator sweep is between 0.25 inches and 2 inches lower than a ground engagement point of the gauge wheel. The planter assembly may have a downforce control unit that is operably connected to one or more planter row units. Each downforce control unit may be individually controlled by a control device. The control device can be operated to selectively engage one or more of the downforce control units to control the downforce applied to all or less than all of the planter row units. When a selected planter row unit is moved to a planting position using the hydraulic cylinder, the gauge wheel and the cultivator sweep may be jointly and nearly simultaneously engaged with the ground.

The planter row unit may have a seed tube for directing a seed from a seed meter into a furrow. The cultivator sweep may be laterally aligned with the seed tube.

The planter attachment may be mounted to the planter assembly upfield of the planter row unit. The planter attachment may be mounted to the planter assembly upfield of the planter row unit. Specifically, the planter attachment may be mounted to the planter assembly with an upfield-downfield distance between the cultivator sweep and the seed tube that is less than 24 inches.

A method for planting a crop over a prior stand is disclosed. A cultivating device is mounted to a planter assembly on an upfield side of a planter row unit. The depth of the cultivating device is set to engage the soil when the planter row unit is lowered to a planting position. The prior stand is destroyed. A new seed is planted where the prior stand was destroyed. Once engaged, the depth of the cultivating device may be between ¾″ and 2″ below the surface of the ground. The cultivator device may be aligned with a seed tube of the planter row unit. The planter row unit and the cultivating device are lowered together.

The planter assembly may have a plurality of planter row units. The plurality of planter row units may be lowered together to replant a plurality of crop rows having a compromised stand. Each of the plurality of planter row units may have its own cultivating device that is laterally aligned with the respective planter row unit. It is also possible that a specific row of crops is compromised. We disclose a method for selectively damaging a compromised crop within one or more rows and selectively replanting the selected rows. The planter assembly may have a plurality of planter row units and a plurality of cultivating devices. A first planter row unit is laterally aligned with the first cultivating device. The first planter row unit and the first cultivating device may be jointly lowered in order to cultivate and replant that specific row. The cultivating device may comprise sweeps, tines, discs, spike wheels, or combinations thereof.

A cultivator sweep may be mounted to a planter row unit on its upfield side. The cultivator sweep and planter row unit are lowered together to engage the ground. The depth of the cultivator sweep may be set to engage the soil at a depth of between ¾″ and 1″ when the planter assembly is lowered to a planting position. The first cultivator sweep and the first planter row unit that are laterally aligned may be engaged without engaging a second cultivator sweep and a second planter row unit that are laterally aligned.

The cultivator sweep may be laterally aligned with a seed tube of the planter row unit or with a row of a partially compromised stand. The cultivator sweep damages the partially compromised stand. The planter row unit replants seed in the location where the cultivator sweep damages the partially compromised stand.

A planter attachment may be sold and installed as a separate item from the planter assembly or preinstalled or integrally formed with the planter row unit. The planter attachment has a cultivator sweep and an attachment stem. The attachment stem mounts the cultivator sweep to a planter assembly. The cultivator sweep is positioned at a lateral row position to align with a previous crop stand row. The attachment stem may have an upper stem portion for mounting the planter attachment to the planter assembly. The attachment stem may also have a lower stem portion that is laterally spaced away the upper support portion. A lateral stem connects the upper stem portion and the lower stem portion. The lateral stem may be operable to position the cultivator sweep to be laterally aligned with a seed tube. The planter attachment may have a vertical adjustment mechanism to set the depth of the cultivator sweep relative to a planter row unit.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 is a side perspective of a planter row unit having a resweep attachment, with a soil surface and subsurface elements shown, with a seed tube shown in outline that would otherwise be hidden;

FIG. 2 is a front view of a resweep attachment;

FIG. 3 is a side view of the resweep attachment shown in FIG. 2;

FIG. 4 is a top view of the resweep attachment shown in FIG. 2;

FIG. 5 is a front view of a resweep attachment;

FIG. 6 is a side view of the resweep attachment shown in FIG. 5;

FIG. 7 is a top view of the resweep attachment shown in FIG. 6;

FIG. 8 shows a parts schematic depiction of a planter assembly, a planter row unit, an attachment mounting bracket, and a resweep attachment;

FIG. 9 shows a field diagram with a 4-row planter assembly mounted to a tractor, with the field showing example crop sections of acceptable stands and compromised stands; and

FIG. 10 shows a field diagram overlaid with replant prescriptions blocks.

### DETAILED DESCRIPTION

After an initial planting, many factors affect the farmer's choice whether to replace an initial stand of corn or allow a compromised stand to grow for the duration of the growing season. Such factors may include: level of initial stand loss, initial planting date, potential replanting date, weather forecast, ability to access replant areas with or without negatively impacting other acceptably established crop, commodity prices, and similar factors.

The decision to replant may be made difficult in situations where the majority of the field may have an acceptable stand and population count, while portions of the field has patches where the stand is compromised to the extent where yield potential is low or possibly non-existent. This may be due to field topography, mechanical damage, mechanical failure, or weather events. Replanting can reestablish production potential and provide ground canopy for weed control.

Patched corn replanting can result in antagonism between the replanted corn that is inter-planted and the initial stand of corn. These two different plantings may be growing and developing in close proximity, within a few inches of each other, at different growth stages. This variation in growth stage and maturity can be detrimental to ear development and yield potential. Inter-planted corn may result in a situation where neither seeding puts on ears that produce significant grain. If they do, it may result in a fraction of the yield potential of non-interplanted plants. Using a separate tillage pass to destroy a compromised stand to replant large sections of a field is optional, due to access and convenience limitations. Separate tillage can be challenging or impossible in patching a portion of a field in a replant situation.

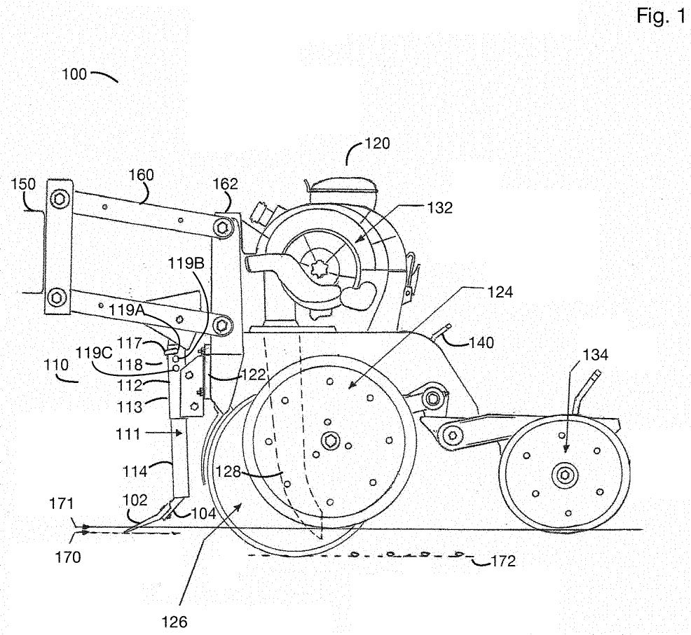

FIG. 1 shows a side view of a resweep attachment 110 for patching and complete field replanting. The resweep attachment 110 is mounted to a planter row unit 120 to eliminate or significantly reduce an initial crop stand, such as corn. A cultivating device 102 damages the existing crop stand by cutting off or removing the initial crop stand from the row before the replant seed is placed in the ground.

As shown in FIG. 1, the resweep attachment 110 is mounted on the front of the planter row unit 120. When the planter row unit 120 is lowered to a planting orientation, as shown in FIG. 1, the cultivating device 102 enters the soil. The resweep attachment 110 has a vertical resweep adjustment mechanism 118 that allows the operator to change the penetration depth of the cultivating device 102. Markings and a rod indicator may be attached to the resweep attachment 110 to aid in the adjustment of the penetration depth and indicate the position of the cultivating device 102.

The resweep attachment 110 is mounted to the row unit faceplate 122. The depth of soil penetration of the cultivating device 102 may be set by the height of the stem 114. The depth of soil penetration of the cultivating device 102 may also be affected by a vertical resweep adjustment mechanism 118. Adjustment to the penetration depth of the cultivating device 102 may be made with a pin-adjust, an air-adjust, a screw-adjust, a hydraulic-adjust, or with other adjustment mounting system. The resweep attachment 110 is shown positioned at an operational depth position 111.

The vertical resweep adjustment mechanism 118 is shown as a pin and hole system. Bracket 112 comprises a sleeve 113 with holes 119A, 119B, and 119C that cooperate with pin 117 and holes 115A and 115B (best shown in FIG. 3) or hole 507 and slotted hole 509 (best shown in FIG. 6), to set the vertical drop of the cultivating device 102.

To terminate the growth of the compromised stand of corn existing in the row, the cultivating device 102 engages at an operational depth indicated by line 170 in FIG. 1. In one example, a planting depth of seed for replanted corn may be approximately two inches below the ground level. The soil surface or ground level is indicated by line 171 in FIG. 1. The seed bed or planting depth is indicated by line 172 in FIG. 1. The operational depth of the resweep attachment may be between 1″ and 2.75″ less than a planting depth of the planter row unit (where the operational depth is higher than the planting depth, as shown in FIG. 1). The operational depth may be at least 0.5″, 0.75″, 1.0″, 1.25″, or 1.5 inches less than a planting depth of the planter row unit. The operational depth may be at least 0.25″, 0.5″, 0.75″, 1.0″, 1.25″, 1.5″, or 2.0 inches below the ground level. The system has vertical adjustment capacity to set the depth setting to run at a depth that would destroy the corn growing point. Operating the device at a minimum depth setting may be advantageous to prevent deep, furrowing out of the seed trench and cause soil slabbing and excess moisture loss. The operational depth, within or outside of the above discussed ranges, may be determined based on soil type, soil moisture level, selected seed planting depth, and growth stage of the plant.

The operational depth may be measured from the gauge wheel 124 as determined by the planter row unit vertical adjustment mechanism 140. For example, the operational depth may be between 0.25 inches and 2 inches lower than a ground engagement point of the gauge wheel 124 of the planter row unit 120. The ground engagement point is the point where the gauge wheel 124 touches the ground while the planter row unit 120 is lowered to initiate planting. In such a configuration, the planter row unit 120 rides upon the ground with a disc opener or a furrow opener 126 of the planter row unit 120. The furrow opener 126 may cut a furrow at a planting depth indicated by line 172. Seed tube 128 guides the path of a seed from the seed meter 132. The closing wheel 134 is mounted to the planter row unit 120 downfield of the furrow opener 126 and operates to close the furrow over the planted seed. The gauge wheel 124 may be vertically adjusted to change the depth of the trench which is cut into the soil and sets the planting depth using the planter row unit vertical adjustment 140. Mounting the resweep attachment 110 to the planter row unit 120 and adjusting the planting depth using the planter row unit vertical adjustment 140 affects the operational depth of the cultivating device 102. Vertical resweep adjustment mechanism 118 provides a depth adjustment relative to the furrow opener 126 and seed tube 128 independent of the planter row unit vertical adjustment 140.

The resweep attachment 110 may be compatible for mounting to a variety of brands of planter assemblies. In one example, the resweep attachment 110 is mounted to a John Deere™ XP row unit planter. The bracket 112 and vertical resweep adjustment mechanism 118 may be adjusted to be properly mounted to a respective faceplate 122 and to provide a height of the stem 114 that achieves the selected operational depth 170. The bracket 112 may also be designed to mount the resweep attachment 110 to the toolbar 150. The resweep attachment 110 may also be compatible with a variety of brands of row cleaners, residue managers, and no-till coulter attachment systems, as well as combinations of these attachments. These attachments may be labeled as bolt on, pin adjust, screw adjust, and floating.

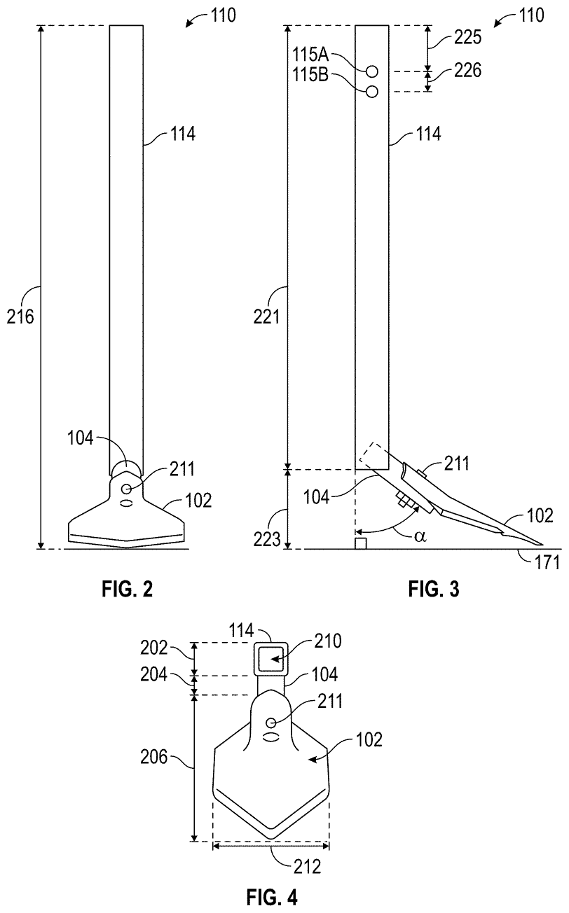

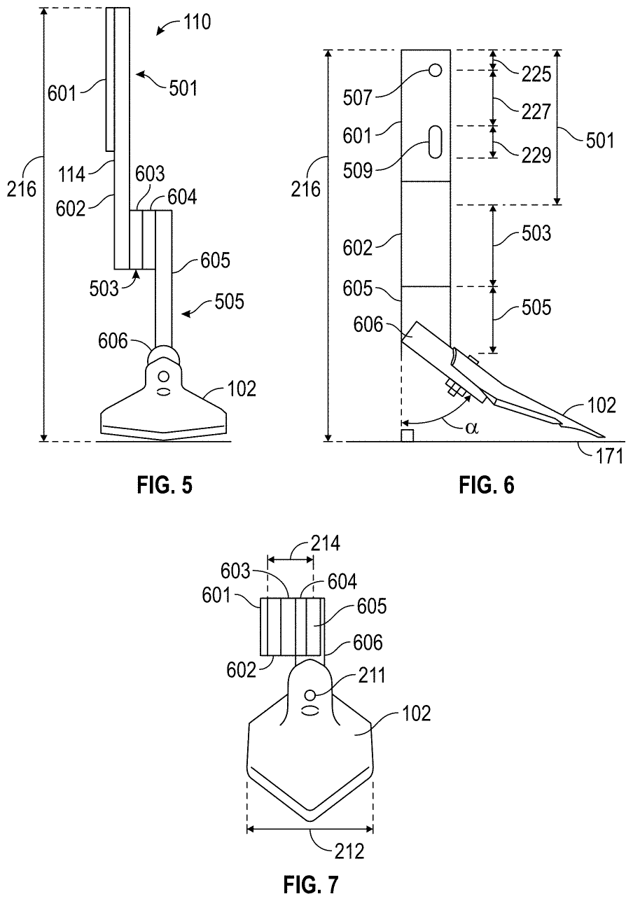

In FIGS. 2-4, an example of a resweep attachment 110 is shown with a total length 216 of approximately 20 inches. The resweep attachment 110 is configured to connect to a fixed Martin™ residue manager mounting bracket with pin adjustment. Stem 114 is shown as a vertical pipe or square tubing with 3/16″ walls having a dimension 202 of 1.5″×1.5″. The length 221 of the stem 114 may be 17 inches. The stem 114 may have a cavity 210 disposed within and running a longitudinal length inside the walls of the square tubing. Stem 114 is shown as having a first hole 115A and a second hole 115B. The first hole 115A and the second hole 115B may be disposed through and perpendicular to the longitudinal axis of the square tubing. Stem 114 may be inserted through sleeve 113 of bracket 112 and then secured by disposing pin 117 through any of holes 119A, 119B, and 119C of the sleeve 113 and first hole 115A and second hole 115B of the stem 114. Connecting piece 104 is shown as extending forwardly, upfield from the stem 114. Connecting piece 104 may be welded, bolted, or otherwise securely fastened to stem 114 and provide a mounting point for cultivating device 102. The cultivating device 102, mounted to the connecting piece 104, may be displaced forwardly, upfield from the stem 114 at a distance 204 that is approximately ⅜ of an inch. Alternatively, cultivating device 102 may be integrally formed with the stem 114. As shown in FIG. 2, this example resweep attachment 110 does not have a lateral offset which may be provided through use of a lateral stem 503 (best shown in FIG. 5). The cultivating device 102 is shown as a Danish sweep duckfoot having a width 212 of approximately 4″. Alternatively, the cultivating device may be a goosefoot sweep, wing sweep, Danish tine sweep, chisel plow sweep, heel sweep, row crop cultivator sweep, and other sweeps having many other shapes, sizes, and widths. As shown in FIGS. 2-4, the cultivating device 102 may have dimensions of 0.25″×4.25″×5.5.″ The cultivating device 102 may have a length 206 of approximately 5.5″ extending forwardly, upfield from the stem 114 towards a triangular-shaped edge (best shown in FIG. 4).

The cultivating device 102 may be canted at an angle α being shown as 50° from vertical in FIG. 3. In this example, a mounting edge of the cultivating device 102 extends backwardly, downfield from the stem 114. The mounting edge may be in a raised position at a distance 223 between 3″ to 3.50 inches above the ground level. Ground level is indicated by line 171 in FIG. 3 and FIG. 6 to show the canted angle α of the cultivating device. The angle α may be between 20° and 90° from vertical or relative to the stem 114, and any range therebetween. One or more bolts may be inserted through an aperture 211 of the cultivating device 102 to secure the cultivating device to the stem 114 (as shown, via the connecting piece 104). The connecting piece 104 may be a straight or angled bar connected directly to the face plate 122 or the stem 114 by welding. The connecting piece may also be inserted into the cavity 210 and connected to the wall(s) of the stem 114. In one example, aperture 211 accommodates an oval head plow bolt having a diameter of ⅜ of an inch. The bolt secures the cultivating device 102 to the connecting piece 104 when disposed through the aperture 211 and fastened with a nut.

Another example of a resweep attachment 110 is shown in FIGS. 5-7, which is configured to connect to a John Deere™ no-till coulter mounting bracket with bolt-on adjustment. As illustrated, the stem 114 has an upper stem portion 501 operable to mount to the planter assembly. The upper stem portion 501 of stem 114 may be bolted to the no-till coulter mounting bracket. Stem 114 also has a lower stem portion 505 that is laterally spaced apart from the upper stem portion 501. The stem 114 may include a S-tine or C-shank. A lateral stem 503 connects the upper stem portion 501 and the lower stem portion 505. The lateral stem 503 may be included where a no-till coulter is laterally offset from a center point.

The width of the lateral stem 503 may be determined based on a lateral offset 214 to laterally align (as opposed to laterally offset) the cultivating device 102 with the seed tube 128. The lateral stem 503 width may be a distance from an outer face of the upper stem portion 501 to an outer face of the lower stem portion 505. In one example, the forwardly, upfield point of the triangular cultivating device 102 may have a lateral offset 214 from the seed tube 128 of 1.5 inches. The lateral alignment of the cultivating device 102 with the seed tube 128 may be acquired by placement of a flat bar or a plurality of flat bars between the upper stem portion 501 and the lower stem portion 505 to form the lateral offset 214 set by a width of the lateral stem 503 from a left-hand side to a right-hand side. As shown in FIG. 5, the upper stem portion 501 may include a 0.25″×2″×5″ flat bar 601 and a 0.5″×2″×9″ flat bar 602 with joined faces. The lateral stem 503 may include a 0.5″×2″×2″ flat bar 603 and a 0.375″×2″×2″ flat bar 604 with joined faces. The 0.5″×2″×2″ flat bar 603 and the 0.375″×2″×2″ flat bar 604 may be placed between and join a face of each of the upper stem portion 501 and the lower stem portion 505. The lower stem portion 505 may include a 0.5″×2″×4.5″ flat bar 605. The plurality of bars may be joined together by welding or bolt fasteners to make the stem 114 have the selected lateral offset 214. A round bar 606 may connect the lower stem portion 505 to the cultivating device 102. The round bar 606 may be one inch in diameter. A right-side view of a vertical profile of the resweep attachment 110 is shown in FIG. 6. From top to bottom, the 0.25″×2″×5″ flat bar 601, the 0.5″×2″×9″ flat bar 602, and the 0.5″×2″×4.5″ flat bar 605, respectively, are shown in vertical alignment. The length 221 of the stem 114 may be 11.25 inches. The resweep attachment 110, including the stem 114 and the cultivating device 102, may have a total length 216 of 14.75 inches. In a situation where the farmer desires to plant directly over the existing stand, the forwardly, upfield center point of the cultivating device 102 is aligned with the existing stand, which allows the cultivating device 102 to damage the existing stand without disrupting the planting bed. Since the planter row unit 120 follows behind the resweep attachment 110, the planter row unit 120 plants directly into the previous row. This may be advantageous due to the presence of previous seed treatments or fertilizers that are row specific as well as avoiding planting in tractor or implement wheel tracks.

The cultivating device 102 may be laterally aligned with a row of a partially or substantially compromised stand 902 of plants. The new planting row may or may not be laterally aligned with the previously planted row. In one example, the user configures the cultivating device 102 to align with the row of the partially or substantially compromised stand 902 of plants, while the seed tube 128 is laterally offset, providing a lateral offset 214 between the previous row and the new row. In this scenario, the width of the lateral stem 503 may be adjusted for this purpose. A lateral offset 214 may be acquired by manual or automatic adjustment of the lateral stem 503.

The vertical resweep adjustment mechanism 118 may comprise a plurality of holes, first hole 115A and second hole 115B, as shown in FIG. 3, and may comprise a hole 507 and a slotted hole 509, as shown in FIG. 6. A center of first hole 115A may be positioned at a distance 225 that is 2.50 inches from a top end of the stem 114. A center of second hole 115B may be positioned at a distance 226 that is 0.75 inches below the center of first hole 115A or 3.25 inches from a top end of the stem 114. A center of hole 507 may be positioned at a distance 225 that is 0.6875 inches from a top end of the stem 114. A center of slotted hole 509 may be positioned at a distance that is 2.50 inches from a top end of the stem 114 or 1.8125 inches below the center of hole 507. The slotted hole 509 may be 1.50″×0.50″ in size where the top of slotted hole 509 is positioned at a distance 227 that is 1.0625 inches below the center of hole 507 or 1.75 inches from a top end of the stem 114. The length 229 of slotted hole 509 may be 1.50 inches. The slotted hole 509 design may allow the user to make further adjustment to the operational depth position 111 of the resweep attachment 110 before securing the resweep attachment 110. The resweep attachment 110, as represented in FIGS. 5-7, may be set into operational depth position 111 and then secured to a no-till coulter mounting bracket with bolt-on adjustment.

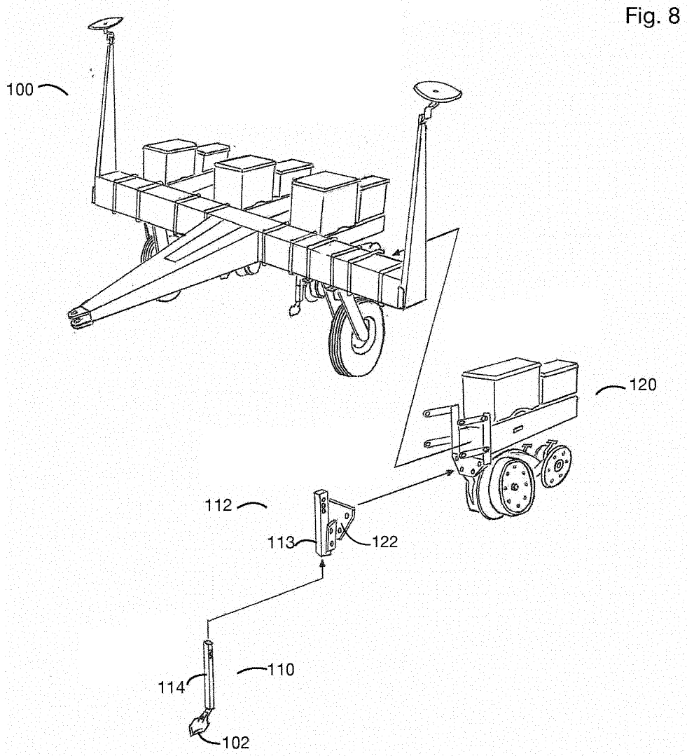

FIG. 8 shows an exploded parts schematic depiction of a resweep attachment 110. The resweep attachment 110 is shown separate from the attachment bracket 112, planter row unit 120, and the planter assembly 100. Arrows show placement orientation of the resweep attachment 110 in relation to the other planter assembly parts.

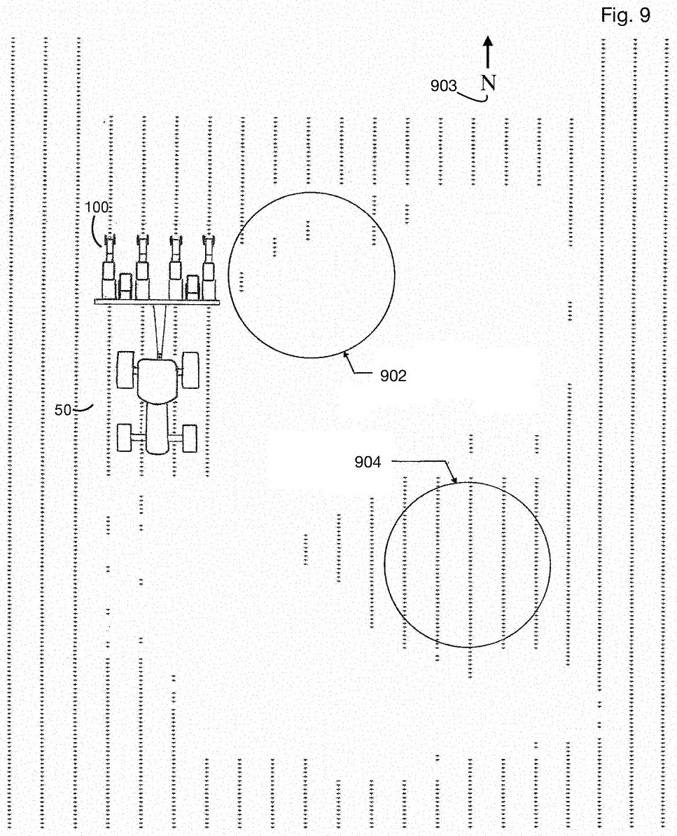

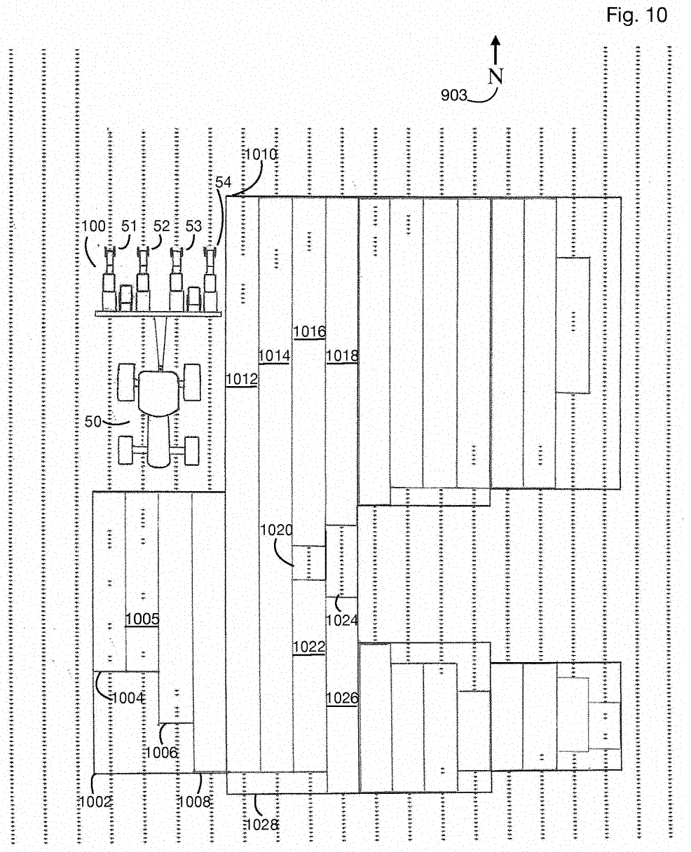

An example of a field having a portion of the field that has an acceptable stand 904 and a portion of the field having a compromised stand 902 is shown in FIG. 9. A tractor 50 is pulling a planter assembly 100 through the field (driving toward the south according to the north arrow 903). The acceptable stand 904 is characterized by even emergence of crop plants within the rows. The compromised stand 902 is characterized by an uneven stand or no emergence of a crop. The compromised stand 902 may be a result of field topography, mechanical damage, mechanical failure, or weather events. The planter assembly 100 shown in FIG. 9-10 is a four-row unit. The planter assembly may comprise more or fewer row units.

The farmer may replant specific rows or blocks of rows as shown in FIG. 10. When the planter assembly reaches block 1002, the operator lowers the planter assembly 100. The cultivating device 102 of each resweep attachment 110 is aligned with a row of the existing compromised stand 902. Under machine control, all or less than all of the four planter row units 120 (with their respective resweep attachments 110) are lowered together. The compromised plants within the four rows in block 1002 are therefore destroyed with the resweep attachment 110 and replanted with the planter assembly 100.

Alternatively, a control system can be provided to individually drive individual planter row units of the planter assembly 100. For example, within block 1002 is block 1004, block 1005, block 1006, and block 1008. The planter assembly 100 has a first planter row unit 51, a second planter row unit 52, a third planter row unit 53, and a fourth planter row unit 54. As illustrated in FIG. 10, the operator would engage all planter row units of the planter assembly 100 when the planter assembly reaches block 1002. In a planter assembly 100 having a control system having individual control over each planter row unit, the operator would disengage the first planter row unit 51 and the second planter row unit 52 when the planter assembly 100 reaches the end of block 1004 and block 1005. The third planter row unit 53 and the fourth planter row unit 54 remain engaged while the planter assembly 100 is over block 1006 and block 1008. The operator would disengage the third planter row unit 53 when the planter assembly 100 reaches the end of block 1006. The fourth planter row unit 54 remains engaged for the entire block 1002, since the entire row within block 1008 is compromised.

Similarly, when pulling the planter assembly 100 over block 1010 in the same orientation that the tractor is facing in the illustrated diagram (driving toward the south according to the north arrow 903), the first planter row unit 51 remains engaged during all of block 1012 and is raised when the planter assembly reaches block 1028. Similarly, the second planter row unit 52 remains engaged during all of block 1014 and is raised when the planter assembly reaches block 1028. The third planter row unit 53 is lowered to engage the ground at blocks 1016 and 1022, with the operator or the control system raising the third planter row unit 53 at block 1020 and 1028. The fourth planter row unit 54 is lowered to engage the ground at blocks 1018 and 1026, with the operator or the control system raising the fourth planter row unit 54 at block 1024. Individual row control allows the operator to remove compromised stands on a row-by-row basis, leaving behind established stands, which may provide the advantage of lower seed cost, and allowing mature plants to remain. Row unit downforce control systems may comprise a mechanical spring, hydraulic cylinder, electric actuators, or an airspring (airbag). Examples of individual row unit downforce control systems include DeltaForce™ by Precision Planting™, individual row hydraulic downforce (IRHD) by John Deere™, Reflex™ by Dawn Equipment Company™ Graham Force™ by Graham Planter™, or True Depth Hydraulic™ by Kinze Manufacturing™. An individual row downforce control unit may produce an upforce pressure to disengage a planter row unit 120. Individual control over replanting selected rows may be advantageous in larger planter assemblies that may have 12, 16, 24, or more planter row units 120.

Row planting prescriptions can be determined and transmitted to a planter control unit electronically. For example, an aerial assessment of the field post-emergence or plant population could be used to indicate compromised field portions and field portions having an acceptable stand. Aerial assessment may be done through operation of an unmanned or manned aerial vehicle. By selecting specific field portions for replanting, a prescription can be generated to replant the specific compromised portions. The assessment system can generate a replant table corresponding to a map, similar to the block diagram of FIG. 10. The replant table combines the replant instructions with row location, such as locating rows by a Globally Positioning System (GPS), a visual guidance system for tracking the rows, proximity sensor, or combinations thereof. The prescription is transmitted to the planter control unit, whether wireless or through a physical connection or memory device. As the operator drives over the field, the prescription instructions may control whether a specific planter row unit is raised or lowered. By mounting the resweep attachment to the faceplate of the planter row unit, a single prescription instruction and a single pass over a specific portion of the field results in both the prior stand being destroyed and seed being replanted.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

I claim:

1. A planter assembly comprising:
a. a planter row unit;
b. a planter attachment mounted to the planter assembly, the planter attachment comprising:
i. an attachment stem; and
ii. a cultivator sweep mounted to the attachment stem.

2. The planter assembly of claim 1, wherein the planter attachment is operable to engage the cultivator sweep with the ground at a cultivator depth that is between 1″ and 2.75″ less than a planting depth of the planter row unit.

3. The planter assembly of claim 1, further comprising:
a. a gauge wheel; and
b. the planter attachment is mounted to the planter row unit such that the cultivator sweep is between 0.25 inches and 2 inches lower than a ground engagement point of the gauge wheel.

4. The planter assembly of claim 1, wherein the planter row unit comprises:
a. a seed tube; and
b. wherein the cultivator sweep is laterally aligned with the seed tube.

5. The planter assembly of claim 1, where the planter attachment is mounted to the planter assembly, upfield of the planter row unit.

6. The planter assembly of claim 1, further comprising:
a. the planter row unit comprising:
i. a seed tube; and
b. where the planter attachment is mounted to the planter row unit, upfield of the planter row unit, and an upfield-downfield distance between the cultivator sweep and the seed tube that is less than 24 inches.

7. The planter assembly of claim 1, further comprising:
a. a gauge wheel mounted to the planter row unit; and
b. a downforce control unit operably connected to individually control the planter row unit to jointly engage the gauge wheel and the cultivator sweep with the ground.

8. The planter assembly of claim 1, where the planter attachment is mounted to a toolbar of the planter assembly.

9. The planter assembly of claim 1, where the planter attachment is mounted to a faceplate of the planter row unit.

10. A method for replanting a crop stand, the method comprising the steps of:
a. mounting a cultivating device to a planter assembly on an upfield side of a planter row unit; and
b. lowering, together, the cultivating device and the planter row unit to engage the ground.

11. The method of claim 10, further comprising the steps of:
a. destroying the crop stand with the cultivating device in a single pass; and
b. replanting, in the single pass, where the crop stand was destroyed.

12. The method of claim 10, further comprising the step of:
a. setting a depth of the cultivating device to engage the ground when the planter row unit is lowered to a planting position, wherein the depth of the cultivating device is between ¾″ and 2″ below a surface of the ground.

13. The method of claim 10, further comprising the step of:
a. aligning, laterally, the cultivating device with a seed tube of the planter row unit.

14. The method of claim 10, further comprising the step of:
a. lowering the planter row unit and the cultivating device together.

15. The method of claim 10, further comprising the step of:
a. cultivating and replanting in a specific row by selectively lowering a first planter row unit that is laterally aligned with a first cultivating device, wherein the planter assembly has a plurality of planter row units and a plurality of cultivating devices.

16. The method of claim 10, wherein the step of lowering further comprises lowering a plurality of cultivating devices and a plurality of planter row units to replant a plurality of rows of the crop stand.

17. The method of claim 10, further comprising the step of:
a. lowering the planter row unit and the cultivating device together to selectively replant a row of the crop stand that is compromised.

18. A planter attachment comprising:
a. a cultivator sweep; and
b. an attachment stem operable to mount the cultivator sweep to a planter assembly at a lateral row position aligned with a previous crop stand.

19. The planter attachment of claim 18, wherein the attachment stem further comprises:
a. an upper stem portion operable to mount to the planter assembly;
b. a lower stem portion laterally spaced apart from the upper stem portion; and
c. a lateral stem connecting the upper stem portion and the lower stem portion, wherein the lateral stem positions the cultivator sweep in lateral alignment with a seed tube.

20. The planter attachment of claim 19, wherein the attachment stem further comprises:
a. a vertical adjustment mechanism operable to set a depth of the cultivator sweep relative to a planter row unit.
